(19) United States
(12) Patent Application Publication
(10) Pub. No.: US 2017/0291046 A1
(43) Pub. Date: Oct. 12, 2017

(54) HARNESS

(71) Applicant: ZEDEL, Crolles (FR)

(72) Inventor: Benoît BOUQUIER, Corenc (FR)

(73) Assignee: ZEDEL, Crolles (FR)

(21) Appl. No.: 15/458,468

(22) Filed: Mar. 14, 2017

(30) Foreign Application Priority Data
Apr. 8, 2016 (FR) 1653152

(51) Int. Cl. A62B 35/00

(52) U.S. Cl. CPC A62B 35/0018; A62B 35/0037

(57) ABSTRACT

A harness including a belt and a pair of thigh straps connected by a strap, the harness including a ventral suspension point including a connector attached to the ventral part of the belt. The connector includes: a rod of longitudinal axis AA mechanically connecting the connector to the belt, a first part including a connecting ring, and mounted movable in rotation with respect to the belt around the rod, a C-shaped second part mounted movable in rotation around a second axis BB parallel to the axis AA and defining a closed contour with the axis BB, the first part and second part being able to be separated from one another so as to allow insertion of at least one accessory for progression on a rope in the C-shaped second part. Also relates to a method for fitting a connector and using a connector on such a harness.

### BACKGROUND OF THE INVENTION

The invention relates to a harness comprising a connector configured to facilitate simultaneous attachment and use of several accessories for progression on a rope and/or safety accessories.

### STATE OF THE ART

During a rock-climbing session, a climber may have to use a descender, a lanyard or a rope clamp, successively using one and the other of the devices. This may occur for example if the climber has to climb up along a rope and then belay someone or rappel. A rope access technician or ‘acrobatic worker’ may have to use these accessories for progression on a rope in the scope of his professional activity.

To be able to switch quickly from one progression accessory to the other, the latter are therefore placed either on the hasp of the harness or on a connector playing the same role as the hasp, the connector being attached to the ventral part of the belt via a strap connecting the pair of thigh straps to the belt.

Multiplication of the devices fitted in the connector may however be an inconvenience for the user, for example if the rope clamp hampers correct operation of the descender, or vice versa. The movements of the rope may be difficult because they are hampered by the accessories for progression on a rope which are not used, and/or by karabiners or quick links which serve the purpose of attaching these progression accessories.

### OBJECT OF THE INVENTION

One object of the invention consists in remedying these shortcomings and in providing a harness comprising a connector which enables easier use of the accessories for progression on a rope such as clamps or descenders.

The harness comprises a belt and a pair of thigh straps connected by a strap. The harness comprises a ventral suspension point comprising a connector attached to the ventral part of the belt. The connector comprises:
a rod of longitudinal axis AA mechanically connecting the connector to the belt,
a first part comprising a connecting ring, and mounted movable in rotation with respect to the belt around the rod,
a C-shaped second part mounted movable in rotation around a second axis BB parallel to the axis AA and defining a closed contour with the axis BB,
the first part and second part being able to be separated from one another so as to allow insertion of external elements into the C-shaped second part.

In preferred manner, the second axis BB is identical to the longitudinal axis AA.

Furthermore, the rod can be located at a distance from the closed contour of the first part of the connector so as to allow the strap to pass between the rod and the connecting ring.

According to a particular embodiment of the invention, the closed contour of the first part can define a first plane, and the rod can be placed at a distance from this first plane. The C-shape of the second part can also define a second plane, and the rod can be placed at a distance from this second plane.

From the structural standpoint, the first part can comprise first attachment means and second attachment means configured to allow passage of the rod, the first and second attachment means being separated by a first distance L1. The C-shaped second part can for its part comprise third attachment means and fourth attachment means configured to allow passage of the rod, the third and fourth attachment means being separated by a second distance L2 smaller than the first distance L1, so that the third and fourth attachment means are situated between the first and second attachment means.

In preferred manner, the first part and second part are mounted without clearance along the axis AA.

Furthermore, the rod can comprise at least a first recess configured to collaborate with a first blocking rod passing through a first hole positioned in the first part or the C-shaped second part so as to prevent translation movements along the axis AA of the first part and of the second part relatively to the rod.

According to an advantageous embodiment, the first part can be configured to be folded onto the second part. The end of the first part opposite the axis AA can be separated by an arc length of more than 0.5 cm from the second part when the first and second parts are folded onto another. As an alternative, the end of the second part opposite the axis AA can be separated by an arc length of more 0.5 cm from the first part when the first and second parts are folded onto one another.

The invention also relates to a method for fitting a connector on a harness comprising the above-mentioned features. For this purpose, the method comprises the following steps:
connecting at least one external device to the C-shaped second part,
connecting the first part, second part and strap by means of the rod so that the strap defines a loop through which the rod passes.

The invention finally relates to a method for housing a connector on a harness comprising the above-mentioned features, in which the first part is positioned on the same side as the pair of thigh straps, and in which the second part is positioned on the same side as the pair of shoulder straps.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 illustrates an embodiment of a harness according to the invention in schematic manner,

FIG. 2 represents the connector when a first part is folded onto the belt in the direction of the pair of thigh straps, and when the second part is folded in the direction of the pair of shoulder straps,

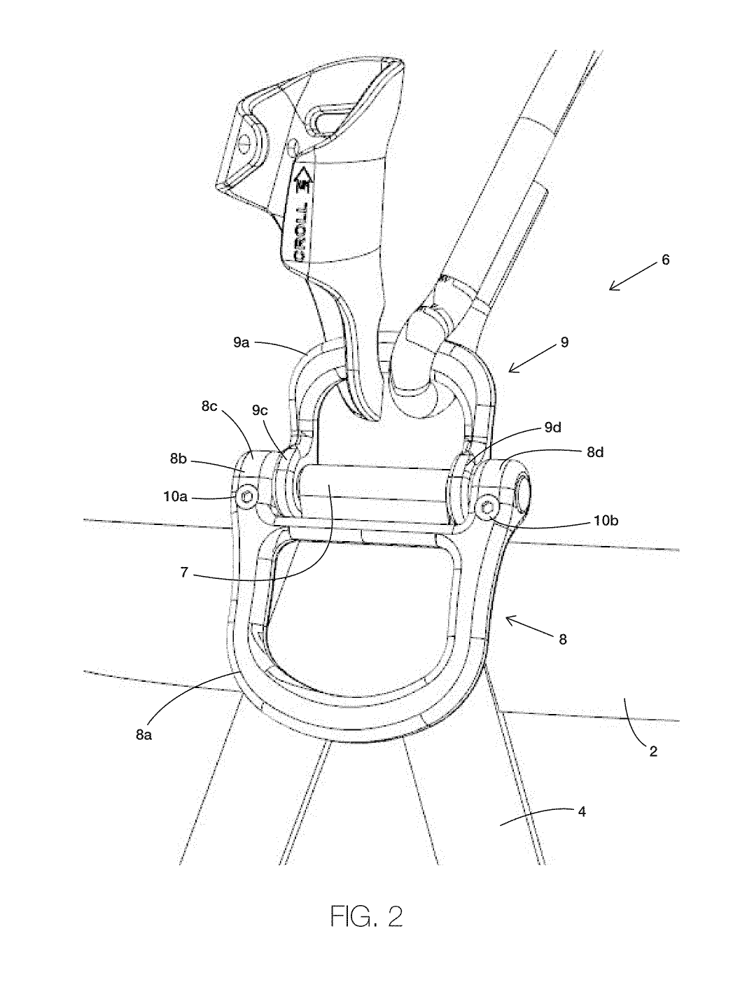

FIG. 3 also represents the connector, but when the first and second parts are folded onto one another,

FIG. 4 represents an exploded view of a connector.

### DETAILED DESCRIPTION

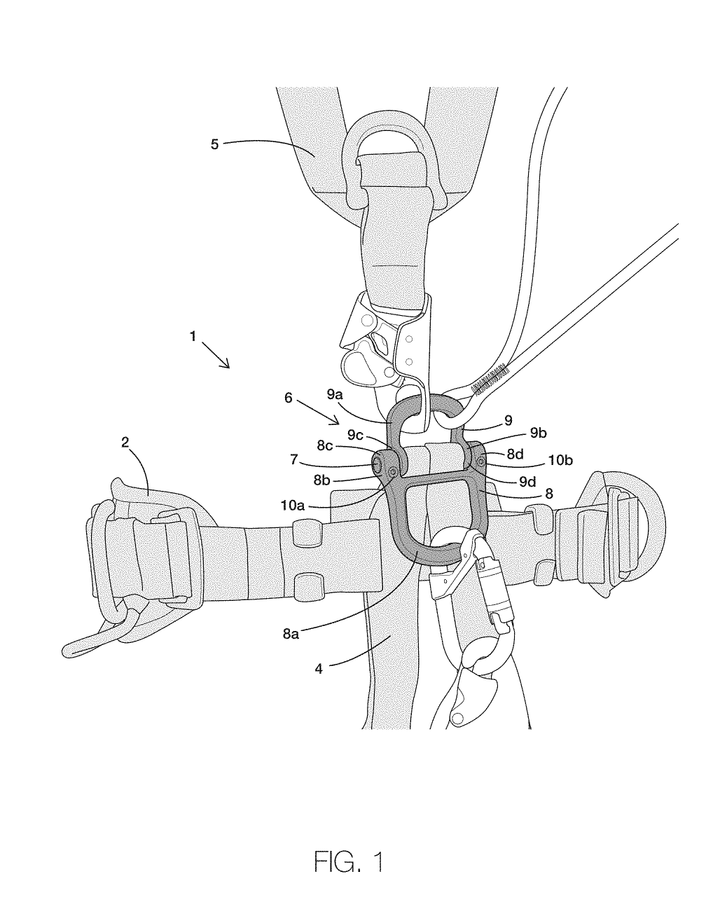

A harness 1 according to the invention comprises a belt 2 and a pair of thigh straps 3 connected to a strap 4. According to the embodiment illustrated in FIG. 1, the harness may comprise shoulder straps 5. But it can also be devoid of shoulder straps. It can be associated with removable shoulder straps or it can be associated with unremovable shoulder straps. In certain embodiments, the shoulder straps 5 are fixed directly to the belt 2 and in other embodiments, the shoulder straps 5 are fixed indirectly to the belt 2, i.e. the mechanical connection between the shoulder straps 5 and the belt 2 is made by means of an intermediate part.

The harness comprises a ventral suspension point enabling the mechanical connection to be made between an attachment point and the belt of the harness when the user is suspended in the harness.

In one embodiment, the harness can be devoid of opening/closing means of the belt 2. If the harness comprises opening/closing means of the belt 2, for example with metal loops or clip-fastening systems, the ventral suspension point is distinct from the opening/closing means of the belt 2.

The harness 1 comprises a connector 6 attached to the belt 2, preferably on the ventral part of the belt 2. The connector 6 defines a first connecting ring and a second connecting ring distinct from the first connecting ring. The first and second connecting rings each define a closed contour. The two connecting rings can move with respect to one another, preferably in rotation and even more preferentially only in rotation.

The connector 6 comprises a rod 7 of longitudinal axis AA which performs the mechanical connection with the belt 2, preferably by means of the strap 4.

The connector 6 comprises a first part 8 defining a closed contour also called connecting ring 8a. The first part 8 is mounted movable in rotation with respect to the belt 2 around the axis AA of the rod 7. The connector 6 also comprises a C-shaped second part 9 mounted movable in rotation around a second axis BB parallel to the axis AA. The second part 9 is mounted movable in rotation with respect to the first part 8 around the second axis BB.

What is meant by C-shape is that the second part 9 does not define a closed contour, and that it is possible to place an accessory for progression on a rope on the second part without having recourse to a karabiner or a quick link. The second part can quite easily be U-shaped, M-shaped, V-shaped, W-shaped, or be of any shape not being a closed contour. However, once the second part 9 has been fitted in the connector 6, a closed contour is formed by means of the second part 9 and its fixing rod, for example rod 7 in the figures. These two parts also define a connecting ring.

The parts of the connector 6 can advantageously be separated by a user in order to be able to insert at least one accessory for progression on the rope on the second C-shaped part 9.

Furthermore, the connector 6 is advantageously attached to the ventral part of the belt 2 by a connection with a strap. The strap defines a loop and the rod 7 is inserted in this loop to mechanically connect the belt 2 to the connector 6. The strap, for example strap 4, advantageously passes between the rod 7 and the closed contour of the first part 8, and surrounds the rod 7. The connector 6 is fitted on the harness 1 at the time when the different parts of the connector 6 are assembled to one another.

The connector 6 is arranged on the harness 1 in such a way that the first part 8 is configured to be placed against the belt 2 or the user in the direction of the pair of thigh straps 3, whereas the second part 9 is configured to be placed against the belt 2 or the user in the direction of the pair of shoulder straps 5. The positions of the first and second parts 8 and 9 can however be reversed without this modifying the general operation of the harness 1.

According to a first embodiment, the axis BB of rotation of the second part 9 can be different from the axis AA of rotation of the first part 8. This means for example that the connector 6 can comprise an additional rod (not represented) of axis BB, and which can be separated from the first and second parts 8 and 9 in order to place an accessory for progression on the rope on the second part 9. This embodiment is however less advantageous as the connector 6 is more bulky than a single axis 7 which simultaneously connects the first part 8 with the belt 2 and second part 9.

The rod 7 is assembled in the connector 6 outside the connecting ring 8a. In advantageous manner, the rod 7 defines a hole with the outer edge of the connecting ring 8a. The strap 4 can therefore pass through the hole without passing through the connecting ring 8a. The closed contour of the connecting ring protects the strap from possible impacts caused by karabiners or other connection parts placed in the connecting ring. This precaution enables the lifetime of the strap to be increased.

As an alternative, the axis BB parallel to the axis AA can correspond to one side of the connecting ring 8a. The second part 9 can be mounted in rotation on the first part 8. The rod 7 is then separated from the axis BB by a part of the strap 4. This embodiment is less advantageous than a common axis as the second part 9 can press against the strap thereby making the latter wear prematurely and/or cause a large lateral play along the axis AA.

According to the embodiment illustrated in the figures and described in the following, the longitudinal axis BB is identical to the longitudinal axis AA, which means that the second part 9 is mounted movable in rotation with respect to the belt 2 around the rod 7.

For the connector to be as functional as possible, it is advantageous to use first and second parts 8 and 9 which have specific three-dimensional shapes.

The first part 8 can be a flat part, i.e. the extreme peripheral area of the part is contained in a plane and/or the internal peripheral area of the connecting ring 8a is contained in a plane. The connectors of the prior art are not advantageous in such an embodiment. The latter are curved towards the outside at the level of their distal part which may be unpleasant for the user as the curved part may come into contact with the abdomen.

It is advantageous to keep a flat connecting ring 8a and to offset the axis AA from this plane. The axis AA can advantageously be offset against the belt 2 when the connecting ring 8a is oriented on the same side as the thigh straps 3.

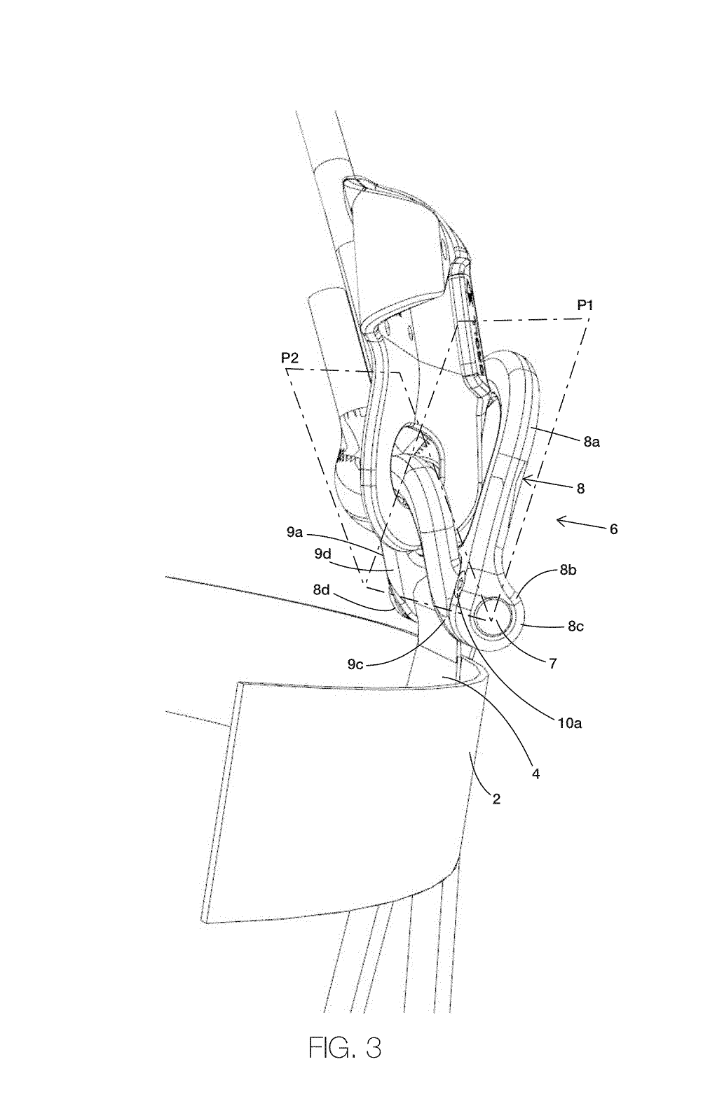

In other words, the connecting ring 8a is contained in a first flat area of the first part 8 so as to define a first plane P1. The rod 7 can advantageously be eccentric with respect to this first plane P1 (cf. FIG. 3).

The first and second parts 8 and 9 are movable in rotation around the rod 7. It is particularly advantageous to provide for the fixing areas of the first part 8 with the rod 7 to be separated by the two fixing areas of the second part 9 with the rod 7 as represented in the different figures.

As an alternative, it is also possible to provide for the fixing areas of the second part 9 with the rod 7 to be separated by fixing areas of the first part 8 with the rod 7. An alternation between the fixing areas of the first and second parts 8 and 9 is preferably to be avoided as the forces in the first and second parts 8 and 9 are less well distributed when the two parts are folded onto one another.

The embodiment illustrated in the figures is nevertheless preferred as it enables folding of the first part 8 on the second part 9 to be limited. In another configuration, it is advantageous to provide additional peripheral pins which increases the surface occupied by the connector 6.

According to the preferred embodiment illustrated in the figures, the first part 8 comprises a first jointed area 8b connecting the connecting ring 8a with the rod 7. In side view, the first part 8 can be L-shaped and be connected to the rod 7 at the level of one of the ends of the L. The connecting ring 8a is therefore a flat area and corresponds to a branch of the L, whereas the other branch of the L is comprised in the first jointed area 8b. The first plane P1 can correspond to any plane passing inside the first part 8 and parallel to the edges of the connecting ring 8a.

Thus, when a vertical force is applied in the connecting ring 8a, the distal part of the first part 8 is slightly offset from the user's abdomen which prevents any hindrance.

In the same way, it may be advantageous to reproduce this particular shape with the second part 9. The axis AA is advantageously offset against the belt 2 when the C-shaped part is oriented on the side where the thigh straps 3 are located.

The C-shaped distal part of the second part 9 is contained in a second flat area 9a of the part so as to define a second plane P2. The rod 7 can advantageously be eccentric with respect to this second plane P2.

On account of the fact that the second part 9 is movable in rotation around the rod 7, this results in the second part 9 being able to comprise a second jointed area 9b connecting the closed contour to the rod 7. Laterally the second part 9 can be L-shaped and be connected to the rod 7 at the level of one of the ends of the L. The second flat area 9a therefore corresponds to one branch of the L, whereas the other branch of the L is comprised in the second jointed area 9b. The second plane P2 can correspond to any plane passing inside the second part 9 and parallel to the edges of the second flat area 9a.

As indicated in the foregoing, to facilitate fitting of the different parts composing the connector 6, one of the parts can be wider than the other in the direction of the axis AA so as to surround the smaller part. For example, the first part 8 can surround the second part 9 at the level of the axis AA.

For this, the first part 8 can comprise first and second attachment means 8c and 8d placed in the fixing areas of the first part, configured to allow passage of the rod 7. The first and second attachment means 8c and 8d are advantageously separated by a first distance L1 along the axis AA. The second part 9 can also comprise third and fourth attachment means 9c and 9d placed in the fixing areas of the second part configured to allow passage of the rod 7. The third and fourth attachment means 9c and 9d are advantageously separated by the second distance L2 along the axis AA which is smaller than the distance L1. In this way, the third and fourth attachment means 9c and 9d are advantageously situated between the first and second attachment means 8c and 8d. This means that the first part 8 surrounds the second part 9.

The attachment means can for example be annular parts or clips, and advantageously be of slightly larger cross-section than the diameter of the rod 7 so as to facilitate rotation of the first and second parts 8 and 9 on the rod 7. What is meant by slightly larger is that the diameter of the annular parts or clips is about 0.1 mm larger than the diameter of the rod 7.

Structurally, it is preferable for the first and second parts 8 and 9 to be fitted without functional clearance in the direction of the axis AA so that the parts cannot translate with respect to one another. The first and second parts 8 and 9 can therefore be only movable in rotation with respect to one another.

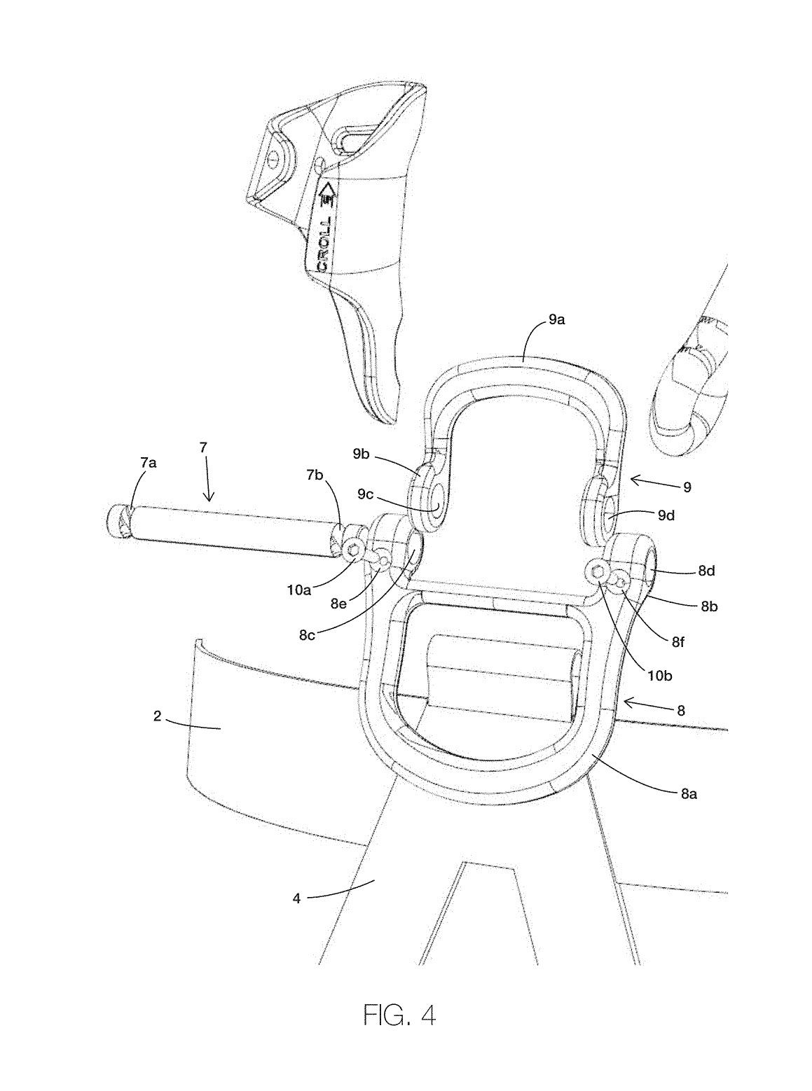

To prevent any lateral movement of the first and second parts 8 and 9 along the rod 7, the latter can comprise first and second recesses 7a and 7b which collaborate with blocking rods 10a and 10b which are inserted in the connector 6 (cf. FIG. 4).

The first and second blocking rods 10a and 10b are advantageously of tubular or cylindrical shape and can for example be screws, rivets, or nails. The width of the first and second recesses 7a and 7b along the axis AA is slightly larger than the diameter of the first and second blocking rods 10a and 10b so that the fixing means can be inserted in the recesses 7a and 7b.

According to the embodiment illustrated in the figures, the first and second blocking rods 10a and 10b are inserted in first and second holes 8e and 8f. As an alternative, the first and second holes could be located on the second part 9. A combination of the embodiments is also possible with a larger number of blocking rods, for example 2, 3, or 4,

In so far as the first and second parts 8 and 25 are fitted without functional clearance along the axis AA, it is also possible to provide a rod 7 comprising a single recess 7a, configured to collaborate with a single blocking rod 10a placed in a single hole positioned indifferently on the first part 8 or on the second part 9.

The position of the first and second holes 8e and 8f can be chosen such that the axes of the first and second blocking rods 10a and 10b are secant or not with the axis AA. If the axes of the first and second blocking rods 10a and 10b are secant with the axis AA, their ends are placed in the recesses but not necessarily right up to the stop. If on the other hand the axes of the first and second blocking rods 10a and 10b are not secant with the axis AA, the latter then tangent the rod 7 at the level of the recesses 7a and 7b so as to allow rotation of the parts 8 and 9 along the axis AA, but not translation of the latter.

In the particular embodiment illustrated in the figures, the first and second holes 8e and 8f open onto the attachment means 8c and 8d and come and tangent the rod 7 at the level of the first and second recesses 7a and 7b. This has the effect of preventing translation movements of the first and second parts 8 and 9 when they are fitted without functional clearance with respect to one another.

Fitting of the first and second parts 8 and 9 on the rod 7 can be performed in two different manners. The more advantageous consists in superposing the first and second flat areas 8a and 9a when the first and second parts 8 and 9 are folded onto one another. It should however be noted that the jointed shape of the first and second parts 8 and 9 prevents them from being completely folded onto one another. The edge of the connecting ring 8a located in proximity to the rod 7 comes up against the stop formed the edge of the C-shaped area 9a.

The value of the offsets between the planes P1 and P2 and the axis AA, and the thicknesses of the first and second parts, are chosen such that the angle formed between the two parts is sufficient to leave mobility for the progression accessories on the rope which will be installed on one or the other of the parts 8 and 9. Progression on the rope is thereby facilitated as the movements of the latter are not hampered by the connecting parts used by the user.

This configuration where the first and second parts are folded onto one another occurs for example when the climber uses a descender attached to the first part 8. Use of the descender has the effect of making the first part 8 swivel towards the pair of shoulder straps 5.

However, to guarantee user comfort, the angle formed between the first and second parts 8 and 9 when they are folded onto one another has to be sufficiently small not to hamper the user. Indeed, if the first and second parts 8 and 9 are too far apart from one another, the second part 9 could exert a pressure on the user and generate discomfort.

On account of the characteristic dimensions of the connector 6 and of those of the accessories for progression on the rope, the first and second parts 8 and 9 can advantageously be separated by an arc length comprised between 0.5 and 3 cm, the arc length being measured with respect to the point farthest from the axis AA.

For example, if the first part 8 is larger than the second part 9, the arc length is measured between the first part and the end of the second part which is opposite the axis AA. In opposite manner, if the first part 8 is smaller than the second part 9, the arc length is measured between the second part and the end of the first part which is opposite the axis AA.

To fit a connector 6 on a harness 1 such as the one which has just been described, it is first of all necessary to attach at least one accessory for progression on the rope on the second C-shaped part 9. This makes it possible to limit the number of karabiners or quick links attached to the connector 6, thereby facilitating use of the latter due to a smaller volume.

The first part 8, the second part 9 and the strap 4 are then connected by means of the rod 7 so that the strap 4 is positioned between the rod 7 and the connecting ring 8a. This enables the strap 4 to be protected from possible friction due to the progression accessories. The connector 6 is then positioned on the ventral part of the belt 2 so as to enable it to be used for the purposes of progression on the rope.

According to the particular embodiment illustrated in the figures, the rod 7 is first of all inserted in the first attachment means 8c of the first part 8, and then in the third attachment means 9c of the second part 9. The rod 7 is inserted in the loop. The rod 7 finally passes through the fourth attachment means 9d of the second part 9 and the second attachment means 8d of the first part 8. The blocking rods 10a and 10b are used in order to prevent any translation of the first and second parts 8 and 9 along the rod 7.

After fitting, it is for example possible to attach a descender on the first part 8 by means of a karabiner or a quick link. This makes it possible to alternate easily between use of the clamp of the rope placed on the second part 9 and use of the descender placed on the first part 8. If a clamp and a descender are positioned in this manner on the connector 6, it is then preferable for the first part 8 to be positioned in the direction of the pair of thigh straps 3, and for the second part 9 to be positioned in the direction of the pair of shoulder straps 5. This configuration is optimal in terms of user comfort, the user not being hampered by the connector 6 during his progression on the rope.

According to the embodiments, the first part 8 defines a closed connecting ring 8a on its own. This configuration enables the strap connecting the connector 6 to the pair of thigh straps 3 to be separated from all the parts which are fitted inside the connecting ring 8a.

In an alternative embodiment, the first part 8 can be a C-shaped part, like the second part 9. The connecting ring is then defined by the assembly of the C-shaped part and of the rod 7 so as to form a closed contour. The first part 8 can be a monoblock part or on the contrary it can be formed by several different parts.

1. Harness comprising a belt and a pair of thigh straps connected to a strap, the harness comprising a ventral suspension point comprising a connector attached to the ventral part of the belt, wherein the connector comprises:
a rod of longitudinal axis AA mechanically connecting the connector to the belt,
a first part comprising a connecting ring, and mounted movable in rotation with respect to the belt around the rod,
a C-shaped second part mounted movable in rotation around a second axis BB parallel to the axis AA and defining a closed contour with the axis BB,
the first part and second part being able to be separated from one another so as to allow insertion of at least one accessory for progression on a rope in the C-shaped second part.

2. Harness according o claim 1, wherein the second axis BB is identical o the longitudinal axis AA.

3. Harness according to claim 1, wherein the rod is located at a distance from the closed contour of the first part of the connector so as to enable passage of the strap between the rod and connecting ring.

4. Harness according to claim 1, wherein the connecting ring defines a first plane, and wherein the rod is placed at a distance from the first plane.

5. Harness according to claim 1, wherein the C-shape of the second part defines a second plane, and wherein the rod is placed at a distance from the second plane.

6. Harness according to claim 2, wherein
the first part comprises first attachment means and second attachment means, configured to allow passage of the rod, the first and second attachment means being separated by a first distance L1,
the C-shaped second part comprises third attachment means and fourth attachment means configured to allow passage of the rod, the third and fourth attachment means being separated by a second distance L2 smaller than the first distance L1, so that the third and fourth attachment means are situated between the first and second attachment means.

7. Harness according to claim 2, wherein the first part and the second part are fitted without clearance along the axis AA.

8. Harness according to claim 7, wherein the rod comprises at least a first recess configured to collaborate with a first blocking rod passing through a first hole positioned in the first part or the C-shaped second part, so as to prevent translation movements along the axis AA of the first part and of the second part relatively to the rod.

9. Harness according to claim 2, wherein the end of the first part opposite the axis AA is separated by an arc length comprised between 0.5 and 3 cm with respect to the second part when the first and second parts are folded onto one another.

10. Harness according to claim 2, wherein the end of the second part opposite the axis AA is separated by an arc length comprised between 0.5 and 3 cm with respect to the first part when the first and second parts are folded onto one another.

11. Harness according to claim 1, wherein the first part is C-shaped and defines the connecting ring closed by means of the rod.

12. Method for fitting a connector on a harness according to claim 1, comprising the following steps:
connecting at least one accessory for progression on a rope to the C-shaped second part,
connecting the first part, the second part and the strap by means of the rod, so that the strap defines a loop through which the rod passes.

13. Method for using a connector on a harness according to claim 1, wherein the first part is positioned on the same side as the pair of thigh straps, and wherein the second part is positioned on the same side as the pair of shoulder straps.
